(19) United States
(12) Patent Application Publication
(10) Pub. No.: US 2010/0227247 A1
(43) Pub. Date: Sep. 9, 2010

(54) NANOCAPILLARY NETWORKS AND METHODS OF FORMING SAME

(76) Inventors: Peter Pintauro, Brentwood, TN (US); Patrick Mather, Manlius, NY (US); Ryszard Wycisk, Beachwood, OH (US)

Correspondence Address: ULMER & BERNE LLP;ATTN: DIANE BELL, 600 VINE STREET, SUITE 2800, CINCINNATI, OH, 45202, US

(21) Appl. No.: 12/575,179

(22) Filed: Oct. 7, 2009

Related U.S. Application Data
(60) Provisional application No. 61/195,400, filed on Oct. 7, 2008.

(51) Int. Cl. H01M 8/10; H01M 8/00

(52) U.S. Cl. 429/479; 429/535; 977/700; 977/840; 977/948

(57) ABSTRACT

A method for forming a nanocapillary network comprises dissolving a polyelectrolyte in a solvent to form a solution; electrospinning the solution to extract polyelectrolyte fibers; and organizing the polyelectrolyte fibers into a network. The method can further comprise processing the network to increase the density of the polyelectrolyte fibers in the network. The method can also further comprise processing the network to interconnect polyelectrolyte fibers. A method for forming a proton exchange membrane comprises dissolving a polyelectrolyte in a solvent to form a solution; electrospinning the solution to extract polyelectrolyte fibers; organizing the polyelectrolyte fibers into a network; and impregnating the network with a polymer to fill voids between polyelectrolyte fibers of the network.

### PRIORITY CLAIM

This application claims priority to and the full benefit of U.S. Provisional Patent Application Ser. No. 61/195,400 filed Oct. 7, 2008, and entitled “FIBER NETWORK MEMBRANE,” which is incorporated by reference as if fully rewritten herein.

### TECHNICAL FIELD

The present invention relates generally to nanocapillary networks and more particularly to nanocapillary networks for use in proton exchange membranes and method of forming such nanocapillary networks.

### BACKGROUND

Fossil fuels are currently the predominant source of energy in the world.

However, due to concerns such as carbon dioxide emissions and the finite nature of the supply of fossil fuel, research and development and commercialization of alternative sources of energy have grown significantly over the preceding decades. One focus of research and development is hydrogen fuel cells. Hydrogen fuel cells can quietly and efficiently generate electrical power, while producing only heat and water as significant byproducts.

One type of hydrogen fuel cell is a proton exchange membrane fuel cell (PEM fuel cell). PEM fuel cells have shown promise as a replacement for internal combustion engines that are currently the dominant source of energy for motor vehicles and other such mobile propulsion applications. A PEM fuel cell can split hydrogen molecules into hydrogen ions, i.e., protons and electrons. The protons can permeate across a polymer membrane that acts as an electrolyte while the electrons can flow through an external circuit and produce electric power.

### SUMMARY

A method for forming a nanocapillary network comprises dissolving a polyelectrolyte in a solvent to form a solution; electrospinning the solution to extract polyelectrolyte fibers; and organizing the polyelectrolyte fibers into a network. The method can further comprise processing the network to increase the density of the polyelectrolyte fibers in the network. The method can also further comprise processing the network to interconnect polyelectrolyte fibers.

A nanocapillary network comprises a plurality of fibers electrospun from a polyelectrolyte solution; a network formed from the plurality of fibers; and a plurality of welds joining individual fibers from the plurality of fibers with other individual fibers from the plurality of fibers.

A method for forming a proton exchange membrane comprises dissolving a polyelectrolyte in a solvent to form a solution; electrospinning the solution to extract polyelectrolyte fibers; organizing the polyelectrolyte fibers into a network; and impregnating the network with a polymer to fill voids between polyelectrolyte fibers of the network.

A proton exchange membrane comprises a nanocapillary network and a polymer matrix encompassing the nanocapillary network. The nanocapillary network comprises a plurality of fibers electrospun from a polyelectrolyte solution; a network formed from the plurality of fibers; and a plurality of welds joining individual fibers from the plurality of fibers with other individual fibers from the plurality of fibers.

### BRIEF DESCRIPTION OF THE DRAWINGS

It is believed that certain examples will be better understood from the following description taken in combination with the accompanying drawings in which:

FIG. 1 is a schematic illustration of apparatus and methods for electrospinning a polymer solution;

FIG. 2 is a schematic illustration of a proton exchange membrane;

FIG. 3a is an optical photograph of a nanofiber mat after electrospinning;

FIG. 3b is an SEM of a nanofiber mat after electrospinning;

FIG. 3c is an SEM of a nanofiber mat after electrospinning;

FIG. 3d is a histograph of fiber diameter distribution for a nanofiber mat after electrospinning;

FIG. 4a is an optical photograph of a nanofiber mat after electrospinning and densification processing;

FIG. 4b is an SEM of a nanofiber mat after electrospinning and densification processing,

FIG. 4c is an SEM of a nanofiber mat after electrospinning and densification processing;

FIG. 4d is a histograph of fiber diameter distribution for a nanofiber mat after electrospinning and densification processing;

FIG. 5a is an optical photograph of a nanofiber mat after electrospinning, densification, and fiber welding processing;

FIG. 5b is an SEM of a nanofiber mat after electrospinning, densification, and fiber welding processing;

FIG. 5c is an SEM of a nanofiber mat after electrospinning, densification, and fiber welding processing;

FIG. 5d is a histograph of fiber diameter distribution for a nanofiber mat after electrospinning, densification, and fiber welding processing;

FIG. 6a is an optical photograph of a proton exchange membrane;

FIG. 6b is an SEM of a freeze-fractured cross-sectional surface of a proton exchange membrane;

FIG. 6c is an SEM of a freeze-fractured cross-sectional surface of a proton exchange membrane;

FIG. 7 is a graph of characteristics of a proton exchange membrane based on fiber volume fraction;

FIG. 8 is a graph of proton conductivity versus relative humidity for a proton exchange membrane;

FIG. 9a is an SEM of a nanofiber mat after electrospinning;

FIG. 9b is a histograph of fiber diameter distribution for a nanofiber mat after electrospinning;

FIG. 10 is a graph of nanofiber mat shrinkage over time based on temperature;

FIG. 11 illustrates an apparatus for nanofiber mat densification;

FIG. 12a is an SEM of an unprocessed electrospun nanofiber mat;

FIG. 12b is an SEM of a nanofiber mat densified by thermal processing;

FIG. 13 is SEMs of nanofibers of a mat in varying stages of weld processing;

FIG. 14 is SEMs of nanofiber mats electrospun from solutions with varying concentrations of dopants; and

FIG. 15 is SEMs of nanofiber mats electrospun from varying polymer solutions.

### DETAILED DESCRIPTION

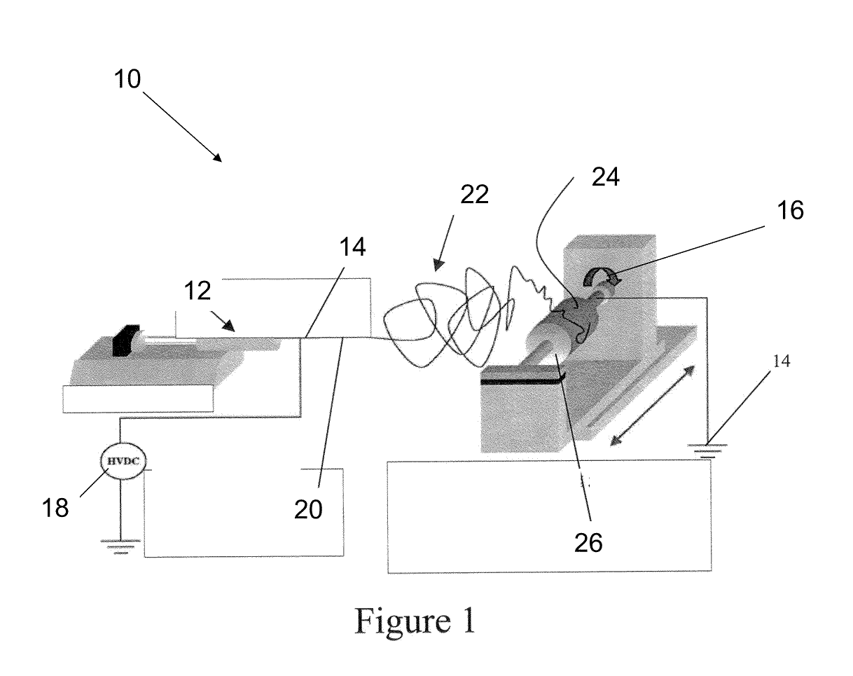

Apparatuses and methods disclosed in this document are described in detail by way of examples and with reference to the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be and should not be construed as mandatory or limiting unless specifically designated as such. Selected examples of apparatuses and methods for forming nanocapillary networks are hereinafter disclosed and described in detail with reference made to FIGS. 1-15.

As is disclosed herein in detail, a nanocapillary network can be used to form a proton exchange membrane for a fuel cell. In one example, a nanocapillary network can be a three-dimensional interconnected network of polyelectrolyte nanofibers, ionomer nanofibers, or other such proton-conducting nanofibers embedded in a generally inert polymer matrix to form a proton exchange membrane. In such a nanocapillary network, the interconnected network of polyelectrolyte nanofibers can provide channels for facile proton conduction. The generally inert polymer matrix can be arranged to make the proton exchange membrane generally impermeable to gases and provide suitable mechanical strength to the proton exchange membrane. In addition, the inert polymer matrix can be arranged to generally limit swelling of the nanocapillary network when the nanocapillary network encounters water or other such moisture.

It will be understood that throughout this disclosure, the terms proton exchange membrane, ion-exchange membrane, and proton conduction membrane can all generally be used interchangeably. In addition, the terms nanocapillary network, nanofiber network, and nanofiber mat can all generally be used interchangeably.

The polyelectrolyte nanofibers can be made of a number of suitable materials and formed by a suitable number of methods or processes. In one example, polyelectrolyte nanofibers can be made from sulfonated poly(arylene ether sulfone) (sPAES). The ion-exchange capacity of sPAES is about 2.5 millimoles per gram, which can make sPAES a suitable material for the fibers of a nanofiber network. In another example, polyelectrolyte nanofibers can be made from a perfluorosulfonic acid (PFSA) such as Nafion. The ion-exchange capacity of Nafion is about 0.909 millimoles per gram, which can make Nafion a suitable material for the fibers of a nanofiber network.

As will be subsequently discussed in detail, one method of forming polyelectrolyte nanofibers can be by an electrospinning process. As polyelectrolyte nanofibers are electrospun, the nanofibers can be gathered and arranged to form a polyelectrolyte nanofiber mat. Once formed, the polyelectrolyte nanofiber mat can undergo suitable processes to change the physical properties of the mat. For example, the polyelectrolyte nanofiber mat can undergo processes to increase the density of the mat. As will be subsequently detailed, a polyelectrolyte nanofiber mat can undergo mechanical or thermal processing, or a combination of mechanical and thermal processing, to increase the density of the mat. The polyelectrolyte nanofiber mat can be further processed to form inter-fiber welds between individual nanofibers. For example, the polyelectrolyte nanofiber mat can be exposed to or treated with a solvent to promote or form welds between nanofibers. Such processing can form a polyelectrolyte nanofiber mat that facilitates proton conduction through the mat.

Once the polyelectrolyte nanofiber mat is formed and optionally densified and/or fiber-welded, voids in the nanofiber mat can be filled with an uncharged and inert polymer to complete a proton exchange membrane. In one example, the uncharged and inert polymer can be a urethane-based polymer. One such urethane-based polymer is Norland Optical Adhesive 63 (NOA63), which is produced by Norland Products of Cranbury, N.J. Such a proton exchange membrane can form a generally non-porous, continuous, and consistent membrane with mechanical properties (in both a dry and a wet state) suitable for use in a PEM fuel cell.

Methods of forming a polyelectrolyte nanofiber mat for use in a proton exchange membrane as described herein allow for flexibility in forming a phase-separated nanomorphology. For example, proton exchange membranes can be customized by the independent selection of a number of variables including, but not limited to, the selection of: the polyelectrolyte polymer that forms the nanofibers; the general diameter of the nanofibers; the fraction of volume occupied by the nanofibers; the inert polymer; and other suitable variables.

In one example, the inert polymer selected can be a generally hydrophobic polymer that can restrict the polyelectrolyte nanofibers from swelling when water or other such moisture is encountered. When swelling is limited, the polyelectrolyte nanofibers can have a generally fixed-charge concentration that is greater than what is generally seen in a homogenous ion-exchange material or membrane.

The welded or interconnected nanofiber structure can generally provide percolation pathways in the polyelectrolyte or ionomer network and can limit isolated domains of charged polymer or dead-end nanochannels. Although the methods and apparatus generally described are directed to proton exchange membranes for fuel cell applications, the methods and nanofiber networks can be used for other purposes, such as electrodialysis separations, sensors, electrolyses, and other such suitable applications.

In one example, a method for forming a proton exchange membrane can include forming a polyelectrolyte nanofiber mat by electrospinning the nanofibers from an ion-exchange polymer solution; processing the nanofiber mat to increase the volume density of fibers in the mat; and forming polymer welds between intersecting fibers in the mat to create a three-dimensional interconnecting network. Any voids between the fibers of the polyelectrolyte nanofiber mat can then be filled with an inert polymer to form the proton exchange membrane.

An example of apparatus 10 for forming a polyelectrolyte nanofiber mat by electrospinning nanofibers from an ion-exchange polymer solution is schematically shown in FIG. 1. The ion-exchange solution can comprise a polyelectrolyte polymer dissolved in a solvent. The electrospinning method can include placing the polyelectrolyte polymer solution in a syringe 12. The syringe 12 can include a metal needle 14. The polyelectrolyte polymer solution in the syringe 12 can be charged by the application of an electrical potential between the metal needle 14 and a ground target 16 spaced a distance away from the metal needle 14. The electrical potential can be applied by charging the metal needle 14 with a voltage from a power supply 18. The electrical potential can be increased until the electrostatic forces in the polyelectrolyte polymer solution overcome the surface tension at the tip of the metal needle 14. As this surface tension is overcome, a fine jet 20 of polyelectrolyte polymer solution containing entangled polyelectrolyte polymer chains can be drawn out of the metal needle 14. As the fine jet 20 travels through the air, at least a portion of the solvent evaporates, resulting in polyelectrolyte polymer nanofibers 22 that dry as they travel through the air. The dry polyelectrolyte polymer nanofibers 22 can be collected on a surface 24 that is in contact with the ground target 16. As shown in FIG. 1, the surface 24 can be on a rotating cylinder or drum 26. In addition to rotational motion, the rotating drum 26 can move horizontally or laterally during the electrospinning process. It will be understood that the electrical potential can be created using a direct current (DC) power supply or an alternating current (AC) power supply.

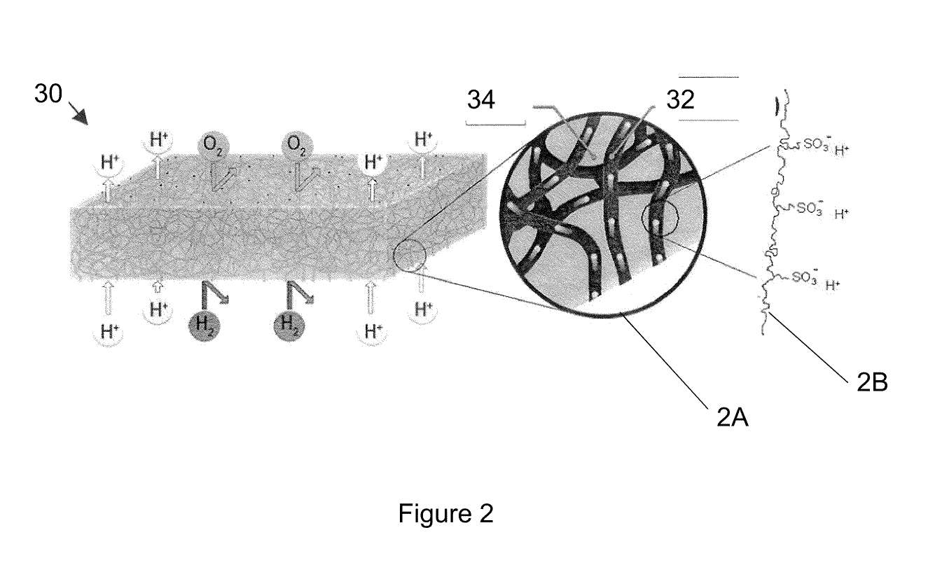

Once the polyelectrolyte polymer nanofibers are collected, the nanofibers can be arranged and formed into a mat, the nanofibers can be welded or annealed to form a network, and the voids of the network can be filled with a generally inert polymer to form a proton exchange membrane. An example of a nanostructure of a resulting proton exchange membrane 30 is shown schematically in FIG. 2. As shown, a three-dimensional polyelectrolyte nanofiber network 32 can be embedded in a generally inert and hydrophobic polymer matrix 34 (as best seen in detail 2A). The fibers of the polyelectrolyte nanofiber network 32 can comprise polymer chains, as schematically shown by detail 2B. As will be understood, the inert and hydrophobic polymer matrix 34 can restrict swelling of the nanofiber network 32 when the proton exchange membrane 30 is exposed to water or other such moisture. In addition, the polymer matrix 34 can provide mechanical strength to the proton exchange membrane 30.

In one example, a polyelectrolyte polymer can be prepared by dissolving 25 percent by weight sPAES in dimethylacetamide. The resulting polyelectrolyte polymer solution can be electrospun to form a mat of sPAES ionomeric nanofibers. As will be further described below, sPAES can be prepared by polycondensating three monomers. The resulting sPAES can have a relatively high molecular weight, an ion-exchange capacity of about 2.5 millimoles per gram, and an intrinsic viscosity of about 0.72 deciliters per gram. When the sPAES polyelectrolyte polymer solution is electrospun, mats can be formed with generally uniform mat thickness and fiber density. In one example, using the apparatus as shown in FIG. 1, polyelectrolyte nanofiber mats can be formed that are 16 centimeters by 6 centimeters. While the polyelectrolyte nanofiber mats are being formed, the drum 30 can be rotated as well as laterally oscillates to encourage a uniform thickness for polyelectrolyte nanofiber mat.

As previously noted, polyelectrolyte nanofiber mats can be compacted and densified under pressure to increase the volume density of the nanofibers within the mat. Such a process can be performed without any substantial change in the diameter of the nanofibers. To create interconnecting protonic pathways between nanofibers in the mat, intersecting nanofibers can be welded or annealed by exposing the densified sPAES mat to dimethylformamide (DMF) vapor. In one example, the sPAES mat can be exposed to DMF at about 25 degrees Celsius for about 18 minutes to weld nanofiber together.

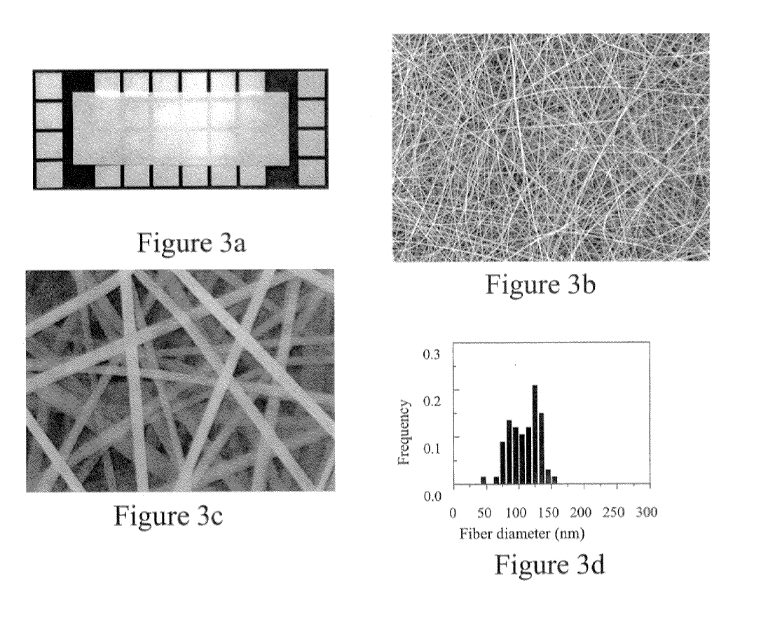

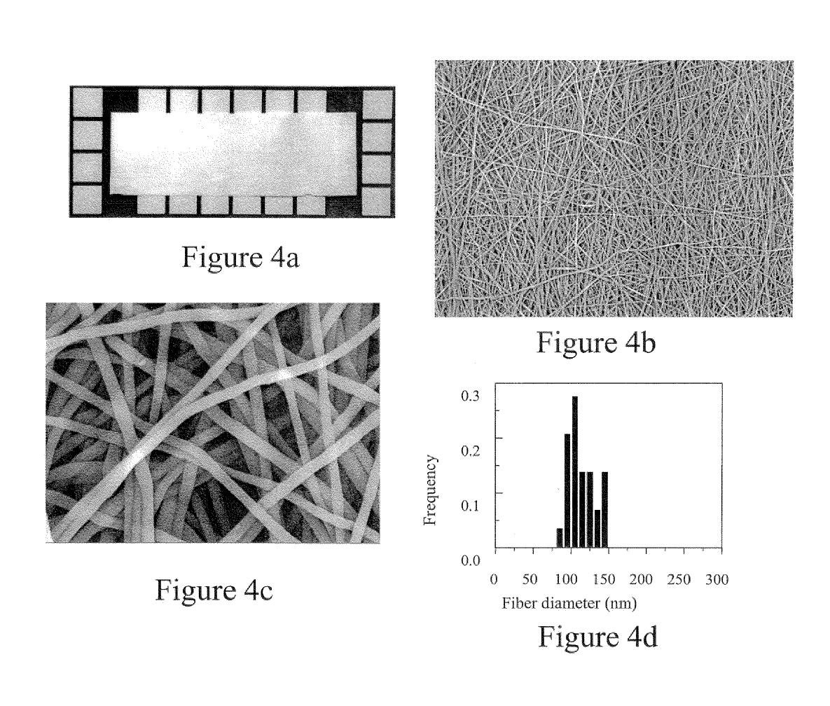

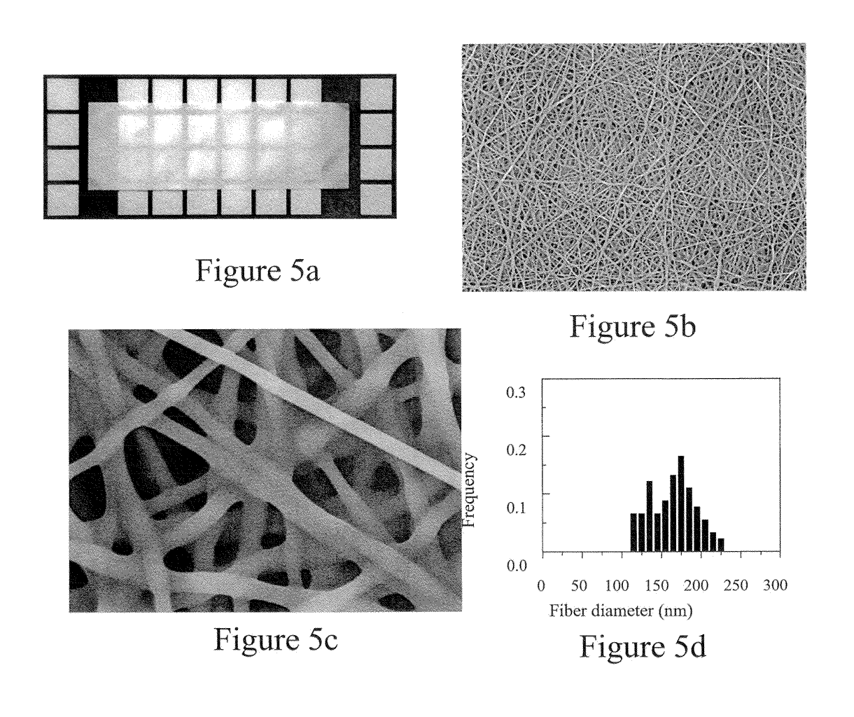

FIGS. 3 through 5 illustrate sPAES nanofiber mats at different stages of processing. FIGS. 3a-3d illustrate a sPAES nanofiber mat after electrospinning of the nanofibers without any additional processing. FIG. 3a is an optical photograph of the sPAES nanofiber mat; FIG. 3b is a scanning electron micrograph (SEM) at 2000 times magnification of the sPAES nanofiber mat; FIG. 3c is an SEM at 30,000 times magnification of the sPAES nanofiber mat; and FIG. 3d is a histograph of the fiber diameter distribution of the sPAES nanofiber mat. FIGS. 4a-4d illustrate the sPAES nanofiber mat after densification processing. FIG. 4a is an optical photograph of the densified sPAES nanofiber mat; FIG. 4b is an SEM at 2000 times magnification of the densified sPAES nanofiber mat; FIG. 4c is an SEM at 30,000 times magnification of the densified sPAES nanofiber mat; and FIG. 4d is a histograph of the fiber diameter distribution of the densified sPAES nanofiber mat. FIGS. 5a-5d illustrate the mat after fiber welding processing. FIG. 5a is an optical photograph of the welded sPAES nanofiber mat; FIG. 5b is an SEM at 2000 times magnification of the welded sPAES nanofiber mat; FIG. 5c is an SEM at 30,000 times magnification of the welded sPAES nanofiber mat; and FIG. 5d is a histograph of the fiber diameter distribution of the welded sPAES nanofiber mat.

For the electrospun sPAES nanofiber mat without additional processing shown in FIG. 3, the volume fraction of nanofibers as compared to overall volume of the mat is approximately 11 percent to 18 percent. The sPAES nanofiber mat thickness is approximately 114 micrometers. The number-average nanofiber diameter is approximately 110 nanometers with a fiber diameter distribution range of approximately 40-160 nanometers.

One example of a densification process for an sPAES nanofiber mat is to mechanically compress or compact the mat at a pressure of about 13,000 pounds per square inch for about 3 minutes at about 25 degrees Celsius. Such a process was performed on the densified sPAES nanofiber mat shown in FIG. 4. Such densification processing increased the nanofiber volume fraction to approximately 64 percent, while the mat thickness decreased to about 32 micrometers. The average nanofiber diameter remained substantially unchanged at about 114 nanometers. After the nanofibers of the mat are welded or annealed, as shown in FIG. 5, the volume fraction of nanofibers further increases to approximately 73 percent and the average nanofiber diameter increased to approximately 165 nanometers. The thickness of the sPAES nanofiber mat remains generally unchanged at about 35 micrometers.

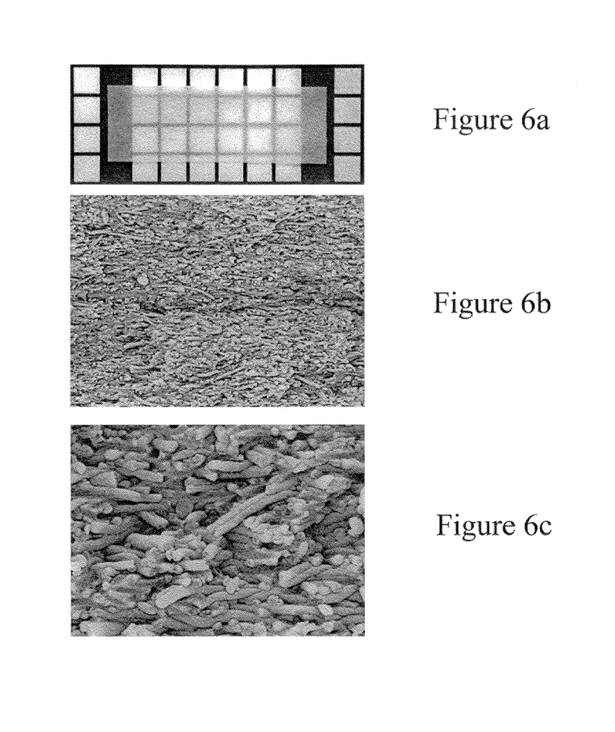

After the sPAES nanofiber mat has undergone densification and welding processing, the nanofiber mat can be impregnated with, for example, a solvent-less, photo-curable, urethane-based prepolymer such as NOA63. The NOA63 adhesive can then be exposed to ultraviolet light for curing to complete the proton exchanging membrane. FIGS. 6a-6c show images of a proton exchange membrane. FIG. 6a is an optical photograph of the proton exchange membrane. FIGS. 6b and 6c are freeze-fractured SEM cross-sectional images of the proton exchange membrane. As is shown, the interfiber voids of the nanofiber network can be filled with a generally uniformly-dense urethane-based polymer.

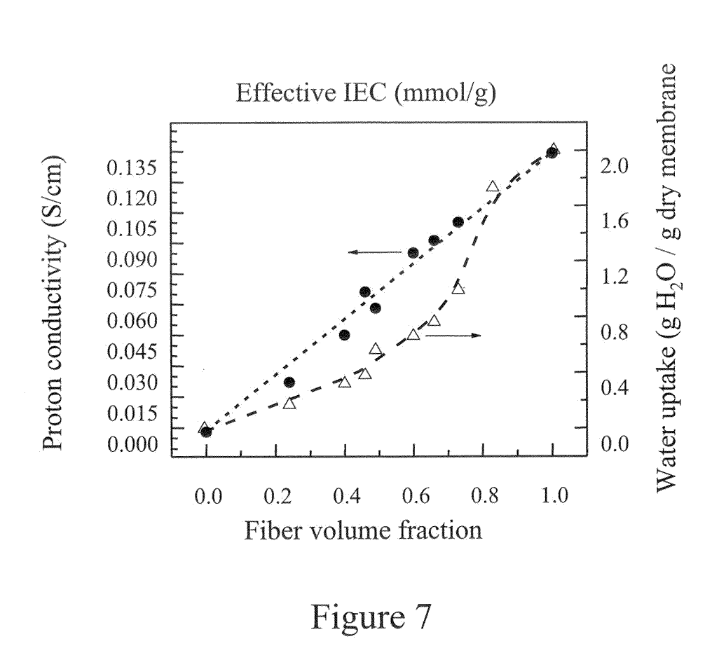

FIG. 7 shows an example of the results of characterization experiments for a proton exchange membrane formed by apparatus and methods disclosed herein. The characteristics of impregnated sPAES nanofiber mats with fiber volume fractions between about 11 percent and about 80 percent are shown in the graph of FIG. 7. A volume fraction of 0.0 percent would correspond to a homogeneous uncharged NOA63 film, and a fiber volume fraction of 100 percent corresponds to a homogeneous film of about 2.5 millimoles per gram of sPAES. FIG. 7 plots proton conductivity against fiber volume fraction and water uptake, i.e., swelling, at about 25 degrees Celsius against fiber volume fraction. FIG. 7 also plots proton conductivity and water uptake against the effective membrane ion-exchange capacity (IEC), which is equal to the product of the fiber volume fraction and fiber polymer ion-exchange capacity. As can be seen, proton conductivity increases linearly with fiber volume fraction in the proton exchange membranes and no percolation threshold is shown. From through-plane conductivity experiments, it can be concluded that the nanofiber network morphology and the proton conductivity is isotropic, i.e., at about 55 percent and about 70 percent fiber volume fractions the in-plane and through-plane conductivities are substantially the same (that is, within experimental error) at about 0.064 S/cm and about 0.086 S/cm, respectively.

As can be further shown in FIG. 7, the compaction or densification steps can improve performance of the proton exchange membrane. Increases in fiber volume fraction can lead to increases in membrane conductivity. Characteristics due to interfiber welding processing can be evaluated by comparing the in-plane proton conductivity of embedded mats (of equal fiber volume fraction) with and without welding. The conductivity for a welded membrane can be approximately 10 percent higher than non-welded membranes (e.g., 0.058 S/cm with welding vs. 0.053 S/cm without welding for an embedded film with a fiber volume fraction of 48 percent). Proton exchange membranes formed with methods disclosed herein also exhibit suitable mechanical properties. The ultimate tensile strength for a nanofiber network with a fiber volume fraction of about 50 percent is approximately 28 MPa at about 25 degrees Celsius and about 35 percent relative humidity.

Proton exchange membranes formed with methods disclosed herein also show good gas barrier properties and low defects. Steady-state oxygen permeability experiments were conducted at about 25 degrees Celsius and about 50 percent relative humidity for a proton exchange membrane with nanofiber volume fraction of about 60 percent and a thickness of about 45 micrometers. The resulting oxygen permeability is about 0.18 Barrers.

Other polymers or blends of polymers can be used to form polyelectrolyte nanofibers for a proton exchange membrane. In one example, sPAES is blended with sulfonated Octaphenyl Polyhedral Oligomeric SilSesquioxanes (sPOSS) to form a solution for electrospinning polyelectrolyte polymer nanofibers. The blend of sPAES and sPOSS can be electrospun using the methods described herein to form nanofibers that can be arranged to form mats. The nanofiber mats can be densified and fiber welded, and the mats can be impregnated with an inert polymer such as NOA63 to form a proton exchange membrane. The resulting proton exchange membrane can have a proton conductivity of about 0.072 S/cm at about 30 degrees Celsius and at about 80 percent relative humidity. It will be understood that sPAES can be blended with proton conducting inorganic particles other than sPOSS to form a solution from which nanofibers can be electrospun and formed for a proton exchange membrane. Such blends of sPAES and proton conducting inorganic particles can achieve similar results as those described herein.

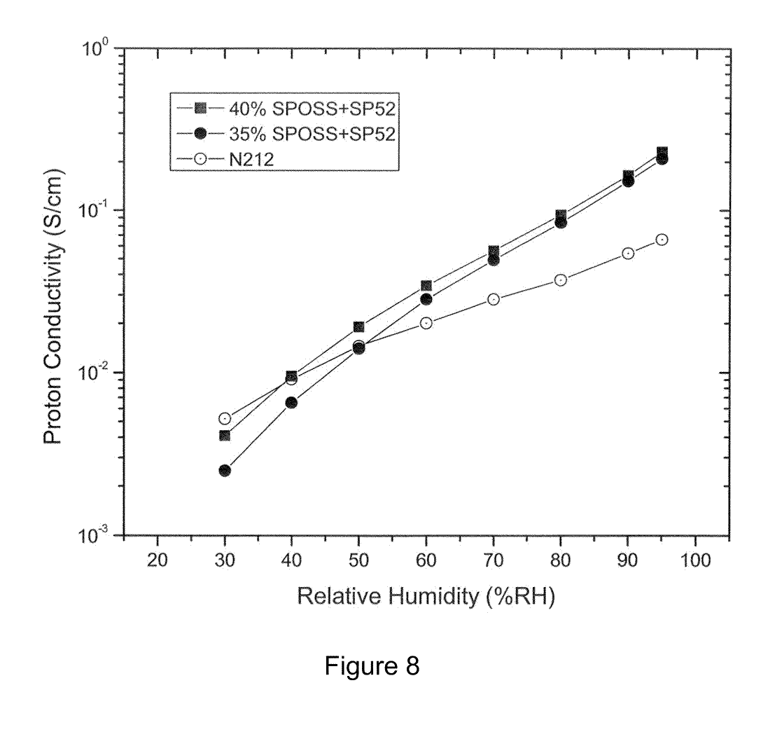

In one example of a nanofiber network formed from a blend of sPAES and sPOSS, the nanofiber mat is prepared by electrospinning a solution of sPAES and sPOSS, where an amount of sPOSS in the solution can be either about 35 percent by weight or about 40 percent by weight. The blend is dissolved in 2-butoxyethanol to form the solution to facilitate electrospinning. The resulting nanofiber mats can include nanofibers with an average diameter in the range of about 300-500 nanometers. The nanofiber mats can be compacted mechanically to increase the fiber volume, and intersecting fibers can be welded by exposing the nanofiber mat to 2-butoxyethanol vapor. Interfiber voids can be filled with an inert polymer such as NOA63, which can be crosslinked in-situ by exposing the membrane to UV light. The resulting proton exchange membranes can have thicknesses of about 50-60 millimeters with a fiber volume fraction of between about 70 percent and about 75 percent. FIG. 8 illustrates proton conductivity data collected at about 30 degrees Celsius at relative humidity between about 30 percent and about 95 percent for membranes with about 35 percent by weight and about 40 percent by weight sPOSS nanofibers. For comparison purposes, Nafion 212 conductivity data is also shown in FIG. 8. The proton conductivity of the nanofiber networks is relatively high and are comparable to that of Nation 212. At about 95 percent relative humidity, the proton conductivity is about 0.23 S/cm. At about 80 percent relative humidity, the conductivity is about 0.094 S/cm. As illustrated by FIG. 8, there can be enhanced proton conductivity with sPOSS loading.

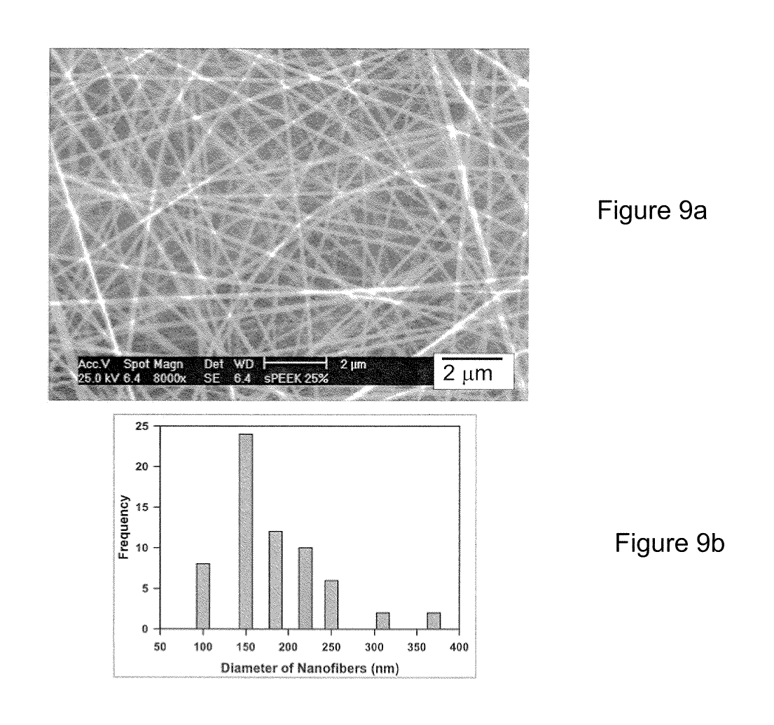

In another example, a nanofiber mat can be formed from sulfonated poly(ether ether ketone)s (sPEEK). The sPEEK can be dissolved at 20 to 30 percent by weight in dimethylacetamide (DMAc) and electrospun into a mat of nanofibers. The nanofibers can be deposited on a rotating drum varying in rotational speed from near 0 to about 5500 revolutions per minute. The drum can move laterally by oscillating about 6 centimeters about a center position, with a frequency ranging from about one cycle per second to about one cycle every twelve seconds. After electrospinning for about 10 hours, nanofiber mats can be formed that are approximately 12 centimeters long, 8 centimeters wide, and between about 50 and 70 micrometers in thickness. FIG. 9a is an SEM of a nanofiber mat electrospun from a solution of sPEEK at 25 percent by weight dissolved in DMAc. FIG. 9b is a histograph of fiber diameter distribution for a sPEEK nanofiber mat after electrospinning and without any additional processing.

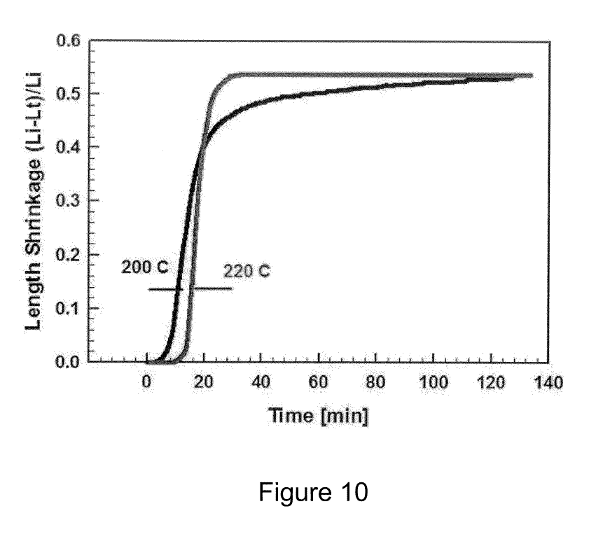

The sPEEK nanofiber mats can be densified by the application of heat or the combination of heat and solvent vapor. As shown in the graph of FIG. 10, the application of heat to a sPEEK nanofiber mat can increase density by contraction of the mat. When heated to about 200 degrees Celsius, the mat can increase its density by contracting or shrinking approximately 50 percent over about 50 minutes. The rate of shrinkage can increase as the temperature increases, with about 50 percent shrinkage being achieved in about 20 minutes at about 220 degrees Celsius. Shrinkage of about 50 percent is achieved in about 3 minutes at about 240 degrees Celsius.

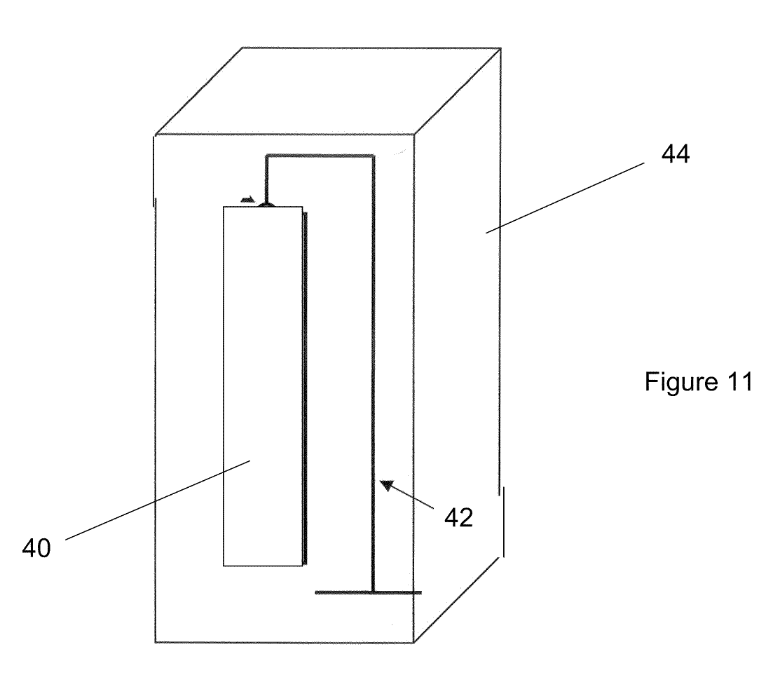

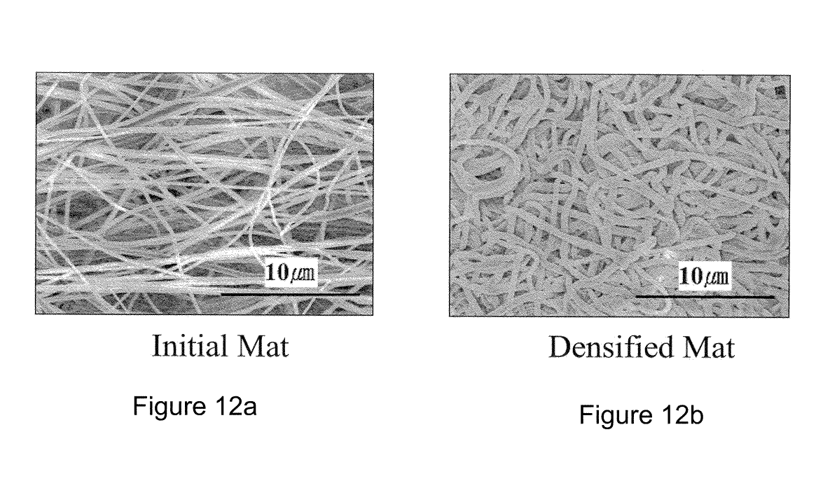

FIG. 11 illustrates another example of a method and apparatus for densifying a mat. A nanofiber mat 40 can be suspended from a stand 42 and placed in a nitrogen-purged oven 44 preheated to about 240 degrees Celsius. After about three minutes the nanofiber mat 40 can be removed from the oven 44 and passed through a laminator at room temperature. Such processing can increase the fiber density of a mat by about a factor of three. FIG. 12a is an SEM of an initial nanofiber mat without further processing and 12b is an SEM of a nanofiber mat densified by the process described and shown in FIG. 11. The increase in density can be seen by comparing FIG. 12a to FIG. 12b.

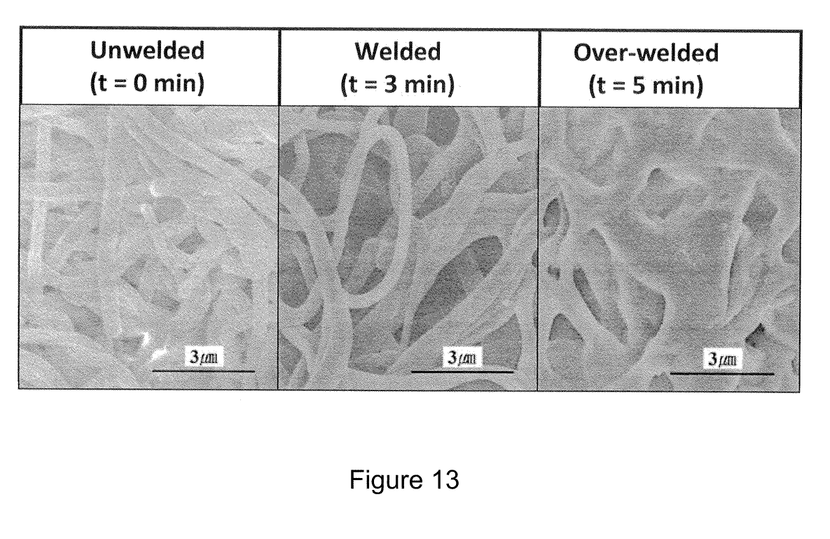

Once the nanofiber mat is densified, the nanofibers can be fiber welded by exposing the nanofibers to solvent vapors such at ethanol at room temperature. The results of a welding process can depend on the amount of time the nanofibers are exposed to the solvent. FIG. 13 is three SEMs of nanofiber mats welded under different exposure times. The effects of exposure time on fiber welding can be seen by comparing the three SEMs. Exposure to ethanol for three minutes yields good fiber welding results. In addition to forming proton exchanging network that more effectively provide pathways through the membrane, fiber welding can also increase the density of the nanofiber mat. For example, exposure to ethanol can further increase density of a mat by about 40 to 60 percent. As described above, the densified and fiber welded nanofiber mat can be embedded in a solvent-less polyurethane photopolymer such as NOA63 to complete the proton exchange membrane.

High-molecular-weight sPAES can be used as the polyelectrolyte polymer. In one example, high-molecular-weight sPAES is formed by the following process. Purified and dried monomers can be used to form sPAES. For example, DCDPS (1.034 g, 3.6 mmol), ds-DCDPS (4.124 g, 8.4 mmol), BP (2.235 g, 12 mmol), and potassium carbonate (1.935 g, ca. 14 mmol) can be added to a three-neck flask equipped with a Dean-Stark trap and reflux condenser. Dried NMP (10 mL) and toluene (5 mL) can be added, and the reaction temperature can be slowly increased to about 150 degrees Celsius and refluxed for about 3 hours. The Dean-Stark trap can then be drained. The temperature can be slowly increased to about 190 degrees Celsius and refluxed for about 16 hours under a nitrogen atmosphere. To increase the molecular weight further of the resulting sPAES copolymer, a relatively small amount (approximately 1 mg) of DCDPS monomer can be added several times every hour to the sPAES solution until the reaction solution became generally viscous at about 190 degrees Celsius under a nitrogen atmosphere. The resulting sPAES solution can be precipitated into distilled water (a fibrous precipitate formed during precipitation). The precipitate can be washed several times with distilled water to remove salts and then vacuum dried at about 120 degrees Celsius for about 48 hours. The actual ds-DCDPS/DCDPS ratio of the sPAES copolymer has been measured as 0.58/0.42. The number average molecular weight (73,500 g/mol) can be determined from gel permeation chromatography based on polystyrene standards using a 0.01 M LiBr/DMF solution as the eluent at a flow rate of 1 mL/min. The intrinsic viscosity (0.72 dL/g) of the polymer was measured at 25 degree Celsius (the polymer was dissolved in a 0.05 M LiBr/NMP solution to decrease the polyelectrolyte effect).

One example of forming a proton exchange membrane is as follows. An about 25 percent by weight sPAES copolymer solution in dimethylacetamide (DMAc) is used to electrospin mats using electrospinning apparatus. A grounded aluminum drum that is about 5 centimeters in diameter and about 18 centimeter in length can be used as the nanofiber collector.

The collecting drum rotates at about 1600 rotations per minute and oscillates laterally at about 25 centimeters per second at an oscillation frequency of about 1.6 cycles per second to produce a relatively large mat of generally uniform thickness and fiber density. The sPAES copolymer solution is pumped out of a syringe with an about 0.41 millimeter internal diameter needle at about 0.04 milliliters per hour, where the needle electrical potential is fixed at about 14 kV. The distance from the tip of the needle to the collector drum is approximately 8 centimeters. The thickness of a resulting electrospun mat can range from about 70 micrometers to about 110 micrometers after about 16 hours of electrospinning The fiber volume fraction can be approximately 18 percent, as determined by the weight of a dry mat as compared to the weight of an equal size and thickness homogeneous film of sPAES.

The electrospun mats can be mechanically compacted at room temperature using a standard bench-top hydraulic press. Applied pressures can range from about 700 psi, which can increase fiber density to about 30 percent, to about 13,000 psi, which can increase the fiber density to about 64 percent. Nanofibers in the densified nanofiber mat can then be welded at nanofiber intersection points by exposing the mat to dimethylformamide (DMF) vapor in a sealed chamber at about 25 degrees Celsius for times ranging from about 7 to 18 minutes. Mats with low fiber densities, i.e., between about 18 and 29 percent, can be exposed for approximately 7 minutes, while mats with higher fiber densities, i.e., approximately 64 percent, can be exposed for approximately 18 minutes. There can be a increase in fiber density of the mats due to the welding process. For example, the fiber density of a mat increased from about 64 percent to 73 percent after fiber welding.

In one example, densified and welded nanofiber mats can be impregnated with an inert polymer as follows. An inert polymer is provided such as UV-curable NOA63. Nanofiber mats can be immersed in a liquid form of NOA63 under vacuum at about 45 degrees Celsius for about 1 hour. Excess adhesive can be optionally removed from the film surfaces by wiping with filter paper multiple times. The NOA63 can be UV cured at a wavelength of about 365 nanometers for about 2 hours (about 1 hour per each side of the mat). Although the present description discusses the use of NOA63, other embedding materials can be used with the methods disclosed herein. Any polymer that can fill the voids between ionomeric nanofibers and limit fiber swelling in water can be used.

In one example, the polyelectrolyte nanofibers are formed from Nafion (1100 EW). The Nafion nanofibers are formed by electrospinning a solution comprising Nafion as disclosed herein. In one example, the Nafion solution can comprise Nafion and a dopant such as high-molecular-weight poly(ethylene oxide) (PEO). The Nafion solution can comprise between about 5 percent and 25 percent Nafion by weight, and a lesser amount of PEO. For example, the Nafion solution can comprise about 1 percent PEO by weight. The Nafion and PEO can be dissolved in a solvent. In one example, the solvent comprises 1-proponol and water at a volume ratio of two-to-one.

The Nafion solution is electrospun to form Nafion nanofibers that are formed into a Nafion nanofiber mat. In one example, a Nafion solution is electrospun by placing the solution into a syringe equipped with a needle. A rotating cylinder is positioned approximately 6 centimeters from the tip of the needle. There is an electrical potential of about 6 kV between the tip of the needle and the grounded rotating cylinder. The flow rate of the solution through the needle is about 0.20 milliliters per hour, and the rotational speed of the cylinder is about 200 revolutions per minute. The resulting mats can have an average nanofiber diameter that is dependent on the concentration of Nafion in the solution. For example, for a solution that is about 15 percent Nafion and PEO by weight, the resulting average nanofiber diameter can be approximately 161 nanometers. For a solution that is about 25 percent Nafion and PEO by weight, the resulting average nanofiber diameter can to approximately 730 nanometers. The nanofiber volume fraction for Nafion nanofiber mats can be about 0.20, and the Nafion nanofiber mat thickness can be about 50 micrometers.

To form a proton exchange membrane from the Nafion nanofiber mat, the nanofibers can be welded or annealed by placing the mat at an elevated temperature of about 140 degrees Celsius for about 30 minutes. The mat can also be densified by applying about 10,000 psi to the mat for about 5 seconds. Such densification can increase the fiber volume fraction to approximately 0.60 to 0.80. The welded and densified mat can then be imbibed with an inert polymer, such as NOA63, and crosslinked by ultraviolet light. In one example, an ultraviolet light of about 365 nanometer wavelength is applied to each side of the membrane for about 60 minutes at room temperature. Optionally, after crosslinking, the proton exchange membrane can be boiled in about 1.0 M sulfuric acid and then in deionized water. Such additional processing can increase the number of membrane fixed charge sites that are in the H+form. In addition, such processing can assist in removing PEO dopants in the nanofibers.

The dopant described herein is PEO. However, it will be understood that other dopants can be used as well. For example, poly(acrylic acid) (PAA), and poly(vinyl alcohol) (PVA) can be used as dopants.

In additional examples, other PFSA polymers can be used to form nanofibers. For example, low equivalent weight PFSA polymers, include 733 EW and 825 EW, can be used. Nanofiber mats can be prepared from a solution that dissolves a mixture of 825 EW polymer and 25 percent by weight or 35 percent by weight sPOSS. A relatively small amount of a high-molecular-weight, water-soluble polymer dopant such as PEO or PAA can be added to the solution. The solution can be electrospun to form nanofibers and form nanofiber mats. Similar to previous descriptions, the nanofiber mats can be processed into proton exchange membranes by: (i) annealing the nanofiber mats at about 140 degrees Celsius for about 5 minutes; (ii) compacting the nanofiber mats at about 10,000 psi for about 5 seconds, which can increase the fiber volume fraction to about 0.70 to 0.75; and (iii) imbibing an inert polymer, such as NOA63, into the nanofiber mats.

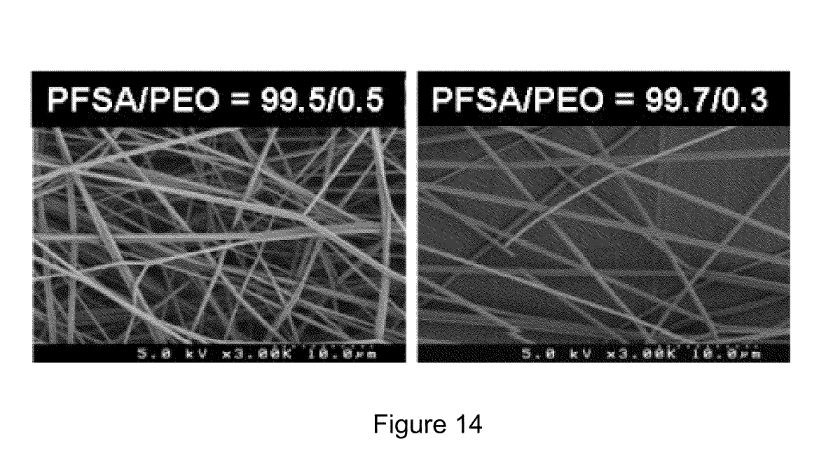

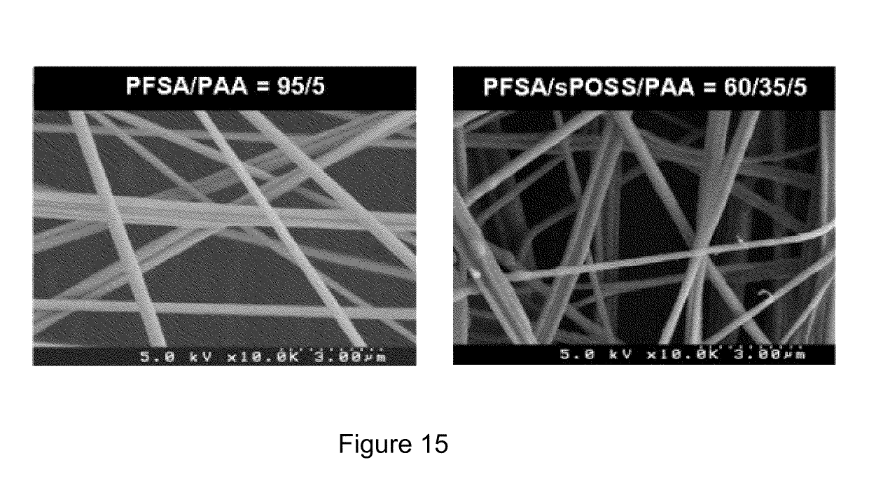

Nanofibers can be electrospun from PFSA polymer solutions with small amount of dopant polymer. For example, about 0.3 percent by weight of PEO (1,000,000 MW) can be added to a PFSA polymer solution. In another example, about 5 percent by weight of PAA (450,000 MW) can be added to a PFSA polymer solution. In such examples, the total polymer concentration in the PFSA polymer solution can be about 15 percent by weight, and the solvent can be a 1-propoanol and water mixture with a two-to-one ratio by weight. For a mixture of PFSA polymer and PEO dopant, a nanofiber mats can be formed under the following electrospinning conditions: electrical potential is about 3 kV; the distance between the tip of a needle and the collection surface is about 6 centimeter; and the solution flow rate is about 0.50 milliliters per hour. FIG. 14 is SEMs of electrospun 825 EW PFSA mats, where the PEO dopant concentration is varied. Nanofibers can also be electrospun using a solution of 825 EW PFSA and PAA as a dopant. The solutions can also optionally include sPOSS. FIG. 15 is SEMs of mats resulting from electrospinning a solution where the solution includes and does not include sPOSS. Where the solution includes about 60 percent PFSA by weight, about 35 percent sPOSS by weight, and about 5 percent PAA by weight, an average fiber diameter is about 247 nanometers, and the fiber volume fraction of about 0.21.

In one example, methods can be applied to further enhance proton conduction property of nanofibers. For example, the polyelectrolyte polymer used to form nanofibers can be doped with molecular silica (trisilanol POSS molecules, where POSS denotes polyhedral oligomeric silsesquioxanes). The molecular silica can be dispersed throughout the polyelectrolyte polymer. Such doping can assist close coordination with acidic ion-exchange groups. The resulting architecture of the nanofiber network can improve the proximity of sulfonic acid groups to hydrophilic termini of POSS moieties. Thus, enabling proton conduction with relatively low overall water content. The silanol groups of POSS can act as a weak base relative to sulfonic acid fixed-charges, and can facilitate deprotonation of SO₃H groups at low membrane water content.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

What is claimed is:

1. A method for forming a nanocapillary network comprising:
dissolving a polyelectrolyte in a solvent to form a solution;
electrospinning the solution to extract polyelectrolyte fibers; and
organizing the polyelectrolyte fibers into a network.

2. The method of claim 1, further comprising processing the network to increase the density of the polyelectrolyte fibers in the network.

3. The method of claim 1, further comprising processing the network to interconnect polyelectrolyte fibers.

4. A nanocapillary network comprising:
a plurality of fibers electrospun from a polyelectrolyte solution;
a network formed from the plurality of fibers; and
a plurality of welds joining individual fibers from the plurality of fibers with other individual fibers from the plurality of fibers.

5. A method for forming a proton exchange membrane comprising:
dissolving a polyelectrolyte in a solvent to form a solution;
electrospinning the solution to extract polyelectrolyte fibers;
organizing the polyelectrolyte fibers into a network; and
impregnating the network with a polymer to fill voids between polyelectrolyte fibers of the network.

6. A proton exchange membrane comprising:
a nanocapillary network comprising:
a plurality of fibers electrospun from a polyelectrolyte solution;
a network formed from the plurality of fibers; and
a plurality of welds joining individual fibers from the plurality of fibers with other individual fibers from the plurality of fibers; and
a polymer matrix encompassing the nanocapillary network.
